(19) United States
(12) Patent Application Publication
(10) Pub. No.: US 2010/0226005 A1
(43) Pub. Date: Sep. 9, 2010

(54) Optical Article and Process for Producing the Same

(75) Inventors: Keiji NISHIMOTO, Ina-shi (JP); Takashi NOGUCHI, Shiojiri-shi (JP); Hiroyuki SEKI, Matsumoto-shi (JP)

Correspondence Address: Hogan Lovells US LLP, 1999 AVENUE OF THE STARS, SUITE 1400, LOS ANGELES, CA, 90067, US

(73) Assignee: SEIKO EPSON CORPORATION, Tokyo (JP)

(21) Appl. No.: 12/710,974

(22) Filed: Feb. 23, 2010

(30) Foreign Application Priority Data
Mar. 4, 2009 (JP) 2009-050322
Aug. 31, 2009 (JP) 2009-199464

(51) Int. Cl. G02B 5/20; B05D 5/06

(52) U.S. Cl. 359/359; 427/162

(57) ABSTRACT

A process for producing an optical article having an antireflection layer formed directly or via another layer on a flexible optical base material, includes: forming a primary layer contained in the antireflection layer; and adding at least any one of carbon, silicon, and germanium to a surface of the primary layer to reduce a resistance.

### BACKGROUND

1. Technical Field

The present invention relates to an optical article having an antireflection function or for imparting an antireflection function, and a process for producing the same.

2. Related Art

In order to reduce reflection of external light on the screen in an optical display device such as a cathode ray tube (CRT), a liquid crystal display device, or a plasma display panel (PDP), an antireflection film (laminate) having a low reflectance to light in the visible spectral region is provided on a front surface of the optical display device. The same shall also apply to window panes, spectacles, goggles, and the like as well as optical display devices. It is also commonly known that by imparting electric conductivity to an antireflection film, electromagnetic shielding performance can be imparted. For example, by providing an antireflection film to which an electromagnetic shielding property is imparted on a front surface of an image display part of PDP, unnecessary electromagnetic waves generated from the inside of PDP can be shielded. Further, by applying an antireflection film to which an electromagnetic shielding property is imparted to window panes of facilities in which wireless LAN is available, electromagnetic waves coming from outside the building can be shielded thereby to prevent entanglement of wires.

As such an antireflection film, a film having a laminate structure in which a high refractive index transparent thin film layer and a metal thin film layer are laminated such that a combination of the high refractive index transparent thin film layer with the metal thin film layer as one repeating unit is repeated three times or more and six times or less, and thereon, the high refractive index transparent thin film layer is laminated is known. However, in this antireflection laminate, the number of the combinations of the high refractive index transparent thin film layer with the metal thin film layer is 3 or more, the thickness thereof is large to reduce transparency, and also the film formation step is increased thereby deteriorating productivity. On the other hand, when the number of the combinations of the high refractive index transparent thin film layer with the metal thin film layer is reduced, the reflectance to light in the low and high wavelength regions of the visible spectral region is increased, and a wavelength region of light to which a sufficiently low reflectance is obtained is decreased.

Therefore, JP-A-2006-184849 discloses an antireflection laminate having a transparent base material, a conductive antireflection layer provided alternately with a high refractive index transparent thin film layer and a metal thin film layer, and a low refractive index transparent thin film layer which is in contact with the outermost layer of the high refractive index transparent thin film layer of the conductive antireflection layer; and an optically functional filter having the antireflection laminate. By providing the low refractive index transparent thin film layer such that it is in contact with the conductive antireflection layer provided alternately with the high refractive index transparent thin film layer and the metal thin film layer, the number of the layers constituting the conductive antireflection layer can be reduced, and as a result, the transparency and productivity are improved.

However, even in the technique disclosed in JP-A-2006-184849, it is necessary to repeat the combination of the high refractive index transparent thin film layer and the metal thin film layer with the high refractive index transparent thin film layer at least one time. Further, the metal thin film layer in the technique disclosed in JP-A-2006-184849 is a layer of a metal such as gold, silver, copper, platinum, aluminum, or palladium, or an alloy containing two or more of these metals, and it is described that among these, silver, an alloy containing silver, or a mixture containing silver is preferred. These metals are not considered to be low in price. Further, gold generally has low adhesiveness and film peeling may be caused. Further, silver is liable to corrode and has a problem that the electric conductivity is decreased by oxidation.

### SUMMARY

One aspect of the invention is directed to a process for producing an optical article having an antireflection layer formed directly or via another layer on a flexible optical base material. This production process includes forming a primary layer contained in the antireflection layer; and adding at least any one of carbon, silicon, and germanium to a surface of the primary layer to reduce a sheet resistance. Carbon, silicon, or germanium is used as a material for a product familiar to the general public, a material for a semiconductor substrate or the like, and is a material available at a relatively low price. Further, such a component can be added to a surface of a layer by a relatively simple method such as vapor (ion-assisted vapor) or sputtering. Further, when a surface of a layer is modified with an amorphous metal of carbon, silicon, or germanium by adding such a component thereto, the resistance of the surface of the layer (surface layer region) can be reduced. Further, carbon, silicon, or germanium can form a compound with a transition metal, most of which has a low resistance. Therefore, by adding carbon, silicon, or germanium to a surface of the primary layer to form a compound in a surface layer region of the primary layer, the resistance of the surface layer region can be reduced.

Further, by modifying the surface of the primary layer, an effect on the optical performance of the primary layer can be minimized. Even if the optical absorptance of the primary layer is decreased by the addition of carbon, silicon, or germanium, the addition amount of such a component can be adjusted such that the decrease can fall within the acceptable range of the optical property of the antireflection layer.

Further, the resistance of the surface layer region of the primary layer is reduced by adding carbon, silicon, or germanium to the surface of the primary layer, the occurrence of peeling of a metal thin film layer or the like can be prevented, and further, an amorphous metal or a compound of carbon, silicon, or germanium has higher corrosion resistance than silver or the like. For example, silicon has high corrosion resistance to most chemicals except HF.

Accordingly, by adopting this production process, the sheet resistance (resistivity) can be reduced while minimizing the effect on the optical performance of the antireflection layer. Accordingly, an optical article which has an electromagnetic shielding effect, an antistatic effect and the like as well as having an antireflection function, and also has high durability can be economically provided.

The primary layer is preferably a layer containing a transition metal capable of forming a compound with at least any one of carbon, silicon, and germanium. Since a conductive surface layer region is formed from a composition which is added for reducing a resistance and a composition contained in the primary layer, there is a high possibility that a mechanical and/or chemical difference between the formed surface layer region and the primary layer is small, and therefore, an optical article having a mechanically and/or chemically more stable antireflection layer is easily produced.

The reduction in the resistance may include adding a transition metal capable of forming a compound with at least any one of carbon, silicon, and germanium to a surface of the primary layer. There is a possibility that the sheet resistance (resistivity) can be further reduced, or the mechanical and/or chemical stability of the surface layer can be improved by allowing the compound to be formed in the surface (surface layer region) of the primary layer.

One of the typical examples of the antireflection layer is a multilayer film containing the primary layer. The production process of the aspect of the invention may further include forming another layer of the multilayer film by superimposing it on the primary layer. In the case where a compound is formed from the added composition and the composition contained in the primary layer, there is a high possibility that a mechanical and/or chemical difference between the primary layer and the another layer formed by superimposing it on the primary layer can be made small, and therefore, an optical article including an antireflection layer having a low resistance and stable performance can be provided.

Typical examples of the optical article of the invention include an antireflection film (laminate). Therefore, the process for producing the optical article of the invention may include forming an adhesive layer on a surface of the optical base material opposite to the surface on which the antireflection layer is formed. The optical article having the adhesive layer can be attached to a display device or the like.

Another aspect of the invention is directed to an optical article having a flexible optical base material and an antireflection layer formed directly or via another layer on the optical base material. The antireflection layer has a primary layer containing a surface layer region having a resistance reduced by adding at least any one of carbon, silicon, and germanium thereto. In this optical article, by adding at least anyone of carbon, silicon, and germanium to the surface of the primary layer, the sheet resistance (resistivity) of the optical article having the antireflection layer containing the primary layer can be reduced. Therefore, an optical article having an electromagnetic shielding function, an antistatic function and the like as well as having an antireflection function can be provided.

Further, the surface layer region having a resistance reduced by adding at least any one of carbon, silicon, and germanium thereto hardly peels off from the primary layer of the antireflection layer and the another layer. Further, the surface layer region containing an amorphous metal and/or a compound containing carbon, silicon, or germanium has relatively higher durability against a chemical such as an acid or an alkali as compared with a metal thin film composed of silver or the like or an ITO layer which is one of the transparent conductive layers.

The primary layer is preferably a layer containing a transition metal capable of forming a compound with at least any one of carbon, silicon, and germanium. A compound having a low resistance can be formed from a composition which is added for reducing a resistance and a composition contained in the primary layer. Accordingly, there is a high possibility that a mechanical and/or chemical difference between the compound contained in the surface layer region and the primary layer can be made small, and therefore, an optical article having a mechanically and/or chemically stable antireflection layer can be provided.

The surface layer region preferably contains a compound of a transition metal with at least any one of carbon, silicon, and germanium. In the case where the compound is formed in the surface layer region, the compound may be a compound formed from the composition contained in the primary layer, or may be a compound formed from a metal added together with any one of carbon, silicon, and germanium. There is a possibility that the sheet resistance (resistivity) can be further reduced, or the mechanical and/or chemical stability of the surface layer region can be further improved by the compound than by an amorphous metal of at least any one of carbon, silicon, and germanium.

One of the typical examples of the antireflection layer is a multilayer film, and the primary layer is one of the layers constituting the multilayer film. Typical examples of the layer constituting the multilayer film is an oxide layer, and the primary layer is preferably a layer containing a transition metal capable of forming a compound with at least any one of carbon, silicon, and germanium, and typically an oxide layer.

Typical examples of the optical article of the invention include an antireflection film (laminate). By attaching the optical article having an adhesive layer formed on a surface of the optical base material opposite to the surface on which the antireflection layer is formed to a display device or the like, an electromagnetic shielding function and the like as well as an antireflection function can be imparted thereto. The optical article of the invention may have a base plate to which the optical base material is attached via the adhesive layer. An optical article containing a light transmissive base plate and having an electromagnetic shielding function and the like as well as an antireflection function can be provided.

Still another aspect of the invention is directed to a system having the above-mentioned optical article and an optical device that inputs and/or outputs light through the optical article. Typical examples of this system include a CRT display, a liquid crystal display device, and a plasma display panel.

### BRIEF DESCRIPTION OF THE DRAWINGS

The invention will be described with reference to the accompanying drawings, wherein like numbers reference like elements.

FIG. 1 is a cross-sectional view showing a structure of an antireflection film containing an antireflection layer.

FIG. 2 is a table showing layer structures of antireflection layers.

FIG. 3 is a table showing layer structures (Type A) and evaluation results of antireflection layers.

FIG. 4 is a table showing layer structures (Type B) and evaluation results of antireflection layers.

FIG. 5A is a cross-sectional view showing a way of measuring a sheet resistance.

FIG. 5B is a plan view showing a way of measuring a sheet resistance.

FIG. 6A is a view showing an outer appearance of a testing device to be used for a scratching step in a chemical resistance test.

FIG. 6B is a view showing an inner structure of the testing device.

FIG. 7 is a view showing that the testing device to be used for the scratching step in the chemical resistance test is rotated.

FIG. 8 is a view showing an outline of a device that determines swelling in a moisture resistance test.

FIG. 9A is a view schematically showing a state in which swelling of the surface of a sample does not occur.

FIG. 9B is a view schematically showing a state in which swelling of the surface of a sample occurs.

### DESCRIPTION OF EXEMPLARY EMBODIMENTS

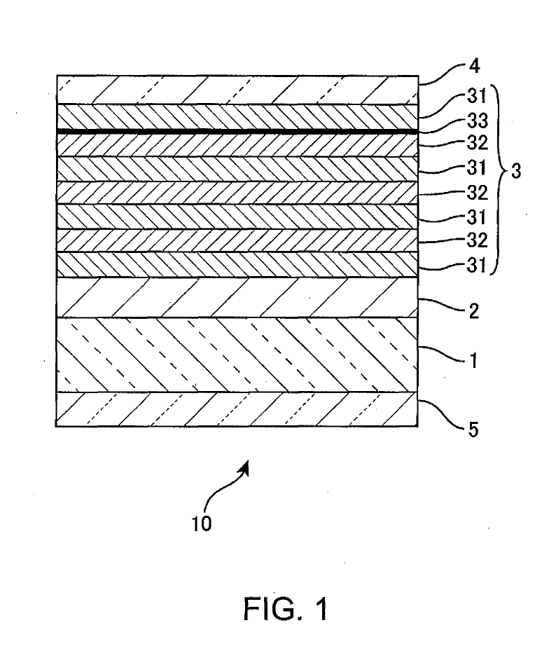

Several embodiments of the invention are described. In FIG. 1, a structure of an antireflection film according to an embodiment of the invention is shown by a cross-sectional view thereof. An antireflection film 10 is one example of the optical article having a light transmissive and flexible optical base material 1 and an antireflection layer 3 formed directly or via another layer on the optical base material 1. The antireflection film 10 shown in FIG. 1 contains a transparent film base material 1, a hard coat layer 2 formed on a surface of the film base material 1, a light transmissive antireflection layer 3 formed on the hard coat layer 2, and an antifouling layer 4 formed on the antireflection layer 3. Further, this antireflection film 10 contains an adhesive layer 5 formed on a surface of the film base material 1 opposite to the surface on which the antireflection layer 3 is formed.

### 1. Antireflection Film

### 1.1 Film Base Material

The film base material 1 may be a base material which is transparent and flexible. As a material thereof, for example, triacetyl cellulose, diacetyl cellulose, acetate butyrate cellulose, polyether sulfone, a polyacrylic-based resin, a polyurethane-based resin, polyester, polycarbonate, polysulfone, polyether, trimethylpentene, polyether ketone, (meth)acrylonitrile, and the like can be exemplified. Among these, a uniaxially or biaxially oriented polyester, particularly polyethylene terephthalate (PET) is excellent in transparency and heat resistance and has no optical anisotropy, and therefore is a preferred material as the film base material 1.

### 1.2 Hard Coat Layer (Primer Layer)

The hard coat layer 2 to be formed on a surface of the film base material 1 is provided for improving the scratch resistance of the antireflection film 10. As a material to be used for the hard coat layer 2, an acrylic-based resin, a melamine-based resin, a urethane-based resin, an epoxy-based resin, a polyvinyl acetal-based resin, an amino-based resin, a polyester-based resin, a polyamide-based resin, a vinyl alcohol-based resin, a styrene-based resin, a silicone-based resin, and a mixture thereof or a copolymer thereof, and the like can be exemplified. One example of the hard coat layer 2 is a silicone-based resin, and a coating composition containing metal oxide fine particles and a silane compound is applied thereto, followed by curing, whereby a hard coat layer can be formed. In this coating composition, components such as colloidal silica and a polyfunctional epoxy compound may be incorporated.

Specific examples of the metal oxide fine particles include fine particles made of a metal oxide such as SiO₂, Al₂O₃, SnO₂, Sb₂O₅, Ta₂O₅, CeO₂, La₂O₃, Fe₂O₃, ZnO, WO₃, ZrO₂, In₂O₃, or TiO₂, or composite fine particles made of metal oxides of two or more metals. These fine particles are dispersed in a dispersion medium such as water, an alcohol or another organic solvent in a colloidal state, and the resulting dispersion can be mixed in the coating composition.

In order to secure the adhesion between the film base material 1 and the hard coat layer 2, a primer layer may be provided between the film base material 1 and the hard coat layer 2. As a resin for forming the primer layer, an acrylic-based resin, a melamine-based resin, a urethane-based resin, an epoxy-based resin, a polyvinyl acetal-based resin, an amino-based resin, a polyester-based resin, a polyamide-based resin, a vinyl alcohol-based resin, a styrene-based resin, a silicone-based resin, and a mixture thereof or a copolymer thereof, and the like can be exemplified. As the primer layer for achieving adhesion, a urethane-based resin and a polyester-based resin are preferred.

Typical examples of a method for forming the hard coat layer 2 and the primer layer include a method in which a coating composition is applied by a dipping method, a spinner method, a spray method, or a flow method, and the resulting coating is dried by heating at a temperature of from 40 to 200° C. for several hours.

### 1.3 Antireflection Layer

Typical examples of the antireflection layer 3 to be formed on the hard coat layer 2 include an inorganic antireflection layer and an organic antireflection layer. The inorganic antireflection layer is composed of a multilayer film, and can be formed by, for example, alternately laminating a low refractive index layer having a refractive index of from 1.3 to 1.6 and a high refractive index layer having a refractive index of from 1.8 to 2.6. The number of layers is about 5 or 7. Examples of the inorganic substance to be used in the respective layers constituting the antireflection layer include SiO₂, SiO, ZrO₂, TiO₂, TiO, Ti₂O₃, Ti₂O₅, Al₂O₃, TaO₂, Ta₂O₅, NdO₂, NbO, Nb₂O₃, NbO₂, Nb₂O₅, CeO₂, MgO, SnO₂, MgF₂, WO₃, HfO₂, and Y₂O₃. These inorganic substances may be used alone or in admixture of two or more of them.

Examples of a method of forming the antireflection layer 3 include a dry method, for example, a vacuum vapor method, an ion plating method, and a sputtering method. In the vacuum vapor method, an ion beam-assisted method in which an ion beam is simultaneously irradiated during vapor can be used.

One of the methods for forming an organic antireflection layer is a wet method. For example, the antireflection layer can also be formed by using a coating composition for forming an antireflection layer containing silica fine particles having a hollow interior (hereinafter also referred to as “hollow silica fine particles”) and an organosilicon compound to form a coating in the same manner as in the case of a hard coat layer or a primer layer. The reason why hollow silica fine particles are used here is that by the incorporation of a gas or a solvent having a lower refractive index than that of silica in the hollow interior, the refractive index of the hollow silica fine particles is further decreased as compared with that of silica fine particles without a hollow, and as a result, an excellent antireflection effect can be imparted. The hollow silica fine particles can be produced by the method described in JP-A-2001-233611 or the like, however, hollow silica fine particles having an average particle diameter of from 1 to 150 nm and a refractive index of from 1.16 to 1.39 can be used. The thickness of this organic antireflection layer is preferably from 50 to 150 nm. When the thickness falls outside the range and is too large or too small, a sufficient antireflection effect may not be obtained.

1.3.1 Surface Layer Region having Reduced Resistance

Further, in the antireflection film 10 according to an embodiment of the invention, by adding at least any one of carbon, silicon, and germanium to a surface of at least one layer contained in the antireflection layer 3, the resistance of a surface layer region of the layer is reduced. In the antireflection film 10 shown in FIG. 1, by adding at least any one of carbon, silicon, and germanium to a surface of a high refractive index layer 32 under the uppermost layer of a low refractive index layer 31, i.e., the uppermost layer of a high refractive index layer 32, the resistance of a surface layer region 33 of the high refractive index layer 32 is reduced.

The reduction in the resistance includes providing a region of an amorphous metal of carbon, silicon, or germanium in the surface layer region 33 of a target layer (in this example, a high refractive index layer) for reduction in the resistance. Further, it includes providing a region of a compound containing at least any one of carbon, silicon, and germanium in the surface layer region 33. In particular, when the target layer 32 for reduction in the resistance contains a transition metal capable of forming a compound with at least any one of carbon, silicon, and germanium, by injecting, adding, or driving carbon, silicon, or germanium into the surface of the target layer 32, the surface layer region 33 can be modified into a region containing the compound.

One of the compounds containing at least any one of carbon, silicon, and germanium is a transition metal-silicon compound (intermetallic compound) called silicide or the like. Examples of the silicide include ZrSi, CoSi, WSi, MoSi, NiSi, TaSi, NdSi, Ti₃Si, Ti₅Si₃, Ti₅Si₄, TiSi, TiSi₂, Zr₃Si, Zr₂Si, Zr₅Si₃, Zr₃Si₂, Zr₅Si₄, Zr₆Si₅, ZrSi₂, Hf₂Si, Hf₅Si₃, Hf₃Si₂, Hf₄Si₃, Hf₅Si₄, HfSi, HfSi₂, V₃Si, V₅Si₃, V₅Si₄, VSi₂, Nb₄Si, Nb₃Si, Nb₅Si₃, NbSi₂, Ta_{4.5}Si, Ta₄Si, Ta₃Si, Ta₂Si, Ta₅Si₃, TaSi₂, Cr₃Si, Cr₂Si, Cr₅Si₃, Cr₃Si₂, CrSi, CrSi₂, Mo₃Si, Mo₅Si₃, Mo₃Si₂, MoSi₂, W₃Si, W₅Si₃, W₃Si₂, WSi₂, Mn₆Si, Mn₃Si, Mn₅Si₂, Mn₅Si₃, MnSi, Mn₁₁Si₁₉, Mn₄Si₇, MnSi₂, Tc₄Si, Tc₃Si, Tc₅Si₃, TcSi, TcSi₂, Re₃Si, Re₅Si₃, ReSi, ReSi₂, Fe₃Si, Fe₅Si₃, FeSi, FeSi₂, Ru₂Si, RuSi, Ru₂Si₃, OsSi, Os₂Si₃, OsSi₂, OsSi_{1.8}, OsSi₃, Co₃Si, Co₂Si, CoSi₂, Rh₂Si, Rh₅Si₃, Rh₃Si₂, RhSi, Rh₄Si₅, Rh₃Si₄, RhSi₂, Ir₃Si, Ir₂Si, Ir₃Si₂, IrSi, Ir₂Si₃, IrSi_{1.75}, IrSi₂, IrSi₃, Ni₃Si, Ni₅Si₂, Ni₂Si, Ni₃Si₂, NiSi₂, Pd₅Si, Pd₉Si₂, Pd₄Si, Pd₃Si, Pd₉Si₄, Pd₂Si, PdSi, Pt₄Si, Pt₃Si, Pt₅Si₂, Pt₁₂Si₅, Pt₇Si₃, Pt₂Si, Pt₆Si₅, and PtSi.

Another compound containing at least any one of carbon, silicon, and germanium is a transition metal-germanium compound (intermetallic compound) called germanide or the like. Examples of the germanide include NaGe, AlGe, KGe₄, TiGe₂, TiGe, Ti₆Ge₅, Ti₅Ge₃, V₃Ge, CrGe₂, Cr₃Ge₂, CrGe, Cr₃Ge, Cr₅Ge₃, Cr₁₁Ge₈, MnGe, Mn₅Ge₃, CoGe, CoGe₂, Co₅Ge₇, NiGe, CuGe, Cu₃Ge, ZrGe₂, ZrGe, RbGe₄, NbGe₂, Nb₂Ge, Nb₃Ge, Nb₅Ge₃, Nb₃Ge₂, NbGe₂, Mo₃Ge, Mo₃Ge₂, Mo₅Ge₃, Mo₂Ge₃, MoGe₂, CeGe₄, RhGe, PdGe, AgGe, Hf₅Ge₃, HfGe, HfGe₂, TaGe₂, and PtGe.

Still another compound containing at least any one of carbon, silicon, and germanium is an organic transition metal called carbide or the like. Examples of the organic transition metal include SiC, TiC, ZrC, HfC, VC, NbC, TaC, Mo₂C, W₂C, WC, NdC₂, LaC₂, CeC₂, PrC₂, and SmC₂.

### 1.4 Antifouling Layer

A water-repellent film or a hydrophilic antifogging film (antifouling layer) 4 is often formed on the antireflection layer 3. The antifouling layer 4 is a layer made of a fluorine-containing organosilicon compound and formed on the antireflection layer 3 for the purpose of improving the water and oil repellent performance of the surface of the optical article (antireflection film) 10. As the fluorine-containing organosilicon compound, a fluorine-containing silane compound described in, for example, JP-A-2005-301208 or JP-A-2006-126782 can be preferably used.

Such a fluorine-containing silane compound can be used as a water-repellent treatment liquid (a coating composition for forming the antifouling layer) prepared by dissolving the compound in an organic solvent at a predetermined concentration. The antifouling layer can be formed by applying this water-repellent treatment liquid (coating composition for forming the antifouling layer) on the antireflection layer. As the application method, a dipping method, a spin coating method, or the like can be used. It is also possible to form the antifouling layer using a dry method such as a vacuum vapor method after filling a metal pellet with the water-repellent treatment liquid (coating composition for forming the antifouling layer).

The thickness of the antifouling layer 4 is not particularly limited, however, it is preferably from 0.001 to 0.5 μm, and more preferably from 0.001 to 0.03 μm. When the thickness of the antifouling layer is too small, the water and oil repellent effect becomes poor, and when the thickness is too large, the surface becomes sticky, and therefore it is not preferred. Further, when the thickness of the antifouling layer is larger than 0.03 μm, the antireflection effect may be decreased.

### 1.5 Adhesive Layer

The adhesive layer 5 is transmissive to light having a wavelength in the visible spectral region and has adhesiveness. The adhesive layer 5 preferably has a refractive index of from 1.45 to 1.7 and an extinction coefficient of almost zero for light having a wavelength of from 500 to 600 nm from the viewpoint of optical performance. As a material of the adhesive layer 5, for example, a rubber-based resin such as polyisoprene rubber, polyisobutylene rubber, styrene-butadiene rubber, or butadiene-acrylonitrile rubber, a (meth)acrylic ester resin, a polyvinyl ether resin, a polyvinyl acetate resin, a polyvinyl chloride-vinyl acetate copolymer resin, a polystyrene resin, a polyamide resin, a polychlorinated olefin resin, a polyvinyl butyrate resin, a silicone resin, a urethane resin, and the like can be exemplified. To any of these resins, an appropriate adhesion-imparting agent such as rosin, dammar, polymerized rosin, a terpene-modified compound, a petroleum resin, or a cyclopentadiene resin may be suitably added. The thickness of the adhesive layer (bonding layer) 5 is preferably from 1 to 100 μm, more preferably from 5 to 500 μm.

### 2. Production of Sample

### 2.1 Example 1 (Sample S1)

### 2.1.1 Selection of Film Base Material and Formation of Hard Coat Layer

As a film base material 1, a transparent polyethylene terephthalate (PET) film having a refractive index of 1.57 was used.

An application liquid (coating liquid) for forming a hard coat layer 2 was prepared as follows. In 20 parts by weight of Epoxy Resin/Silica Hybrid (trade name: Compoceran (registered trademark) E102 (manufactured by Arakawa Chemical industries, Ltd.)), 4.46 parts by weight of an acid anhydride-based curing agent (trade name: liquid curing agent (C2) (manufactured by Arakawa Chemical industries, Ltd.)) was mixed and stirred, whereby an application liquid (coating liquid) was obtained. This coating liquid was applied on the base material 1 to a predetermined thickness using a spin coater, whereby the hard coat layer 2 was formed. The film base material 1 after application was baked at 125° C. for 2 hours.

### 2.1.2 Formation of Antireflection Layer

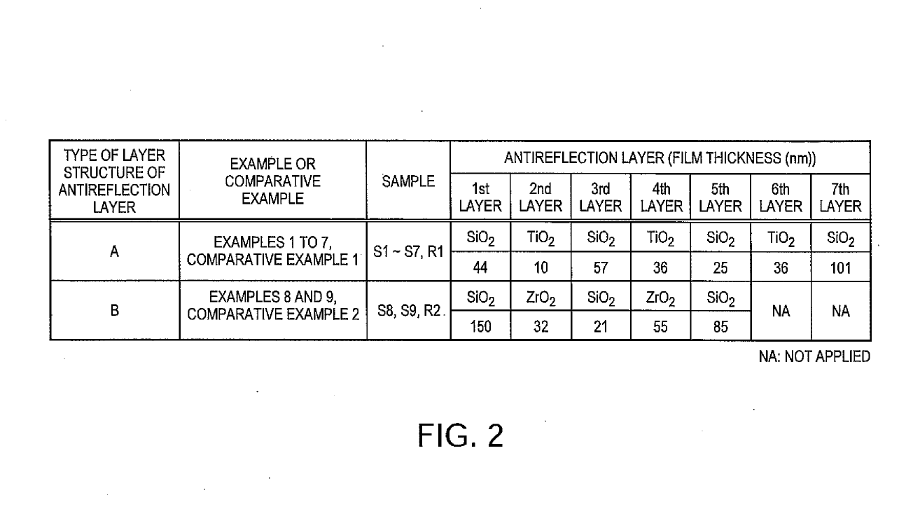

An antireflection layer 3 of an inorganic multilayer film was formed on the hard coat layer 2 by general electron beam vapor with ion assist (so-called IAD method). A layer structure of the antireflection layer 3 of Example 1 is Type A shown in FIG. 2. That is, in the antireflection layer 3 of Example 1, a high refractive index layer 32 is a titanium oxide (TiO₂) layer and a low refractive index layer 31 is a silicon dioxide (SiO₂) layer. Specifically, Sample S1 in which the hard coat layer 2 was formed was placed in a vacuum vapor chamber (not shown), and a crucible filled with a vapor material was placed at the bottom in the vacuum vapor chamber, and then, the vapor material was evaporated by an electron beam. At the same time, by accelerated irradiation of oxygen (Ar was added at the time of forming a TiO₂ layer) ionized using an ion gun, the TiO₂ layer 32 and the SiO₂ layer 31 were alternately formed according to the structure of Type A.

The film forming conditions for the TiO₂ layer and the SiO₂ layer are as follows.

Film Forming Conditions for SiO₂ Layer
Film formation rate: 2.0 nm/sec
Electron beam conditions for heating material
   Accelerating voltage: 7000 V
   Accelerating current: 100 mA
Without ion assist
Film formation temperature: 60° C.

Film Forming Conditions for TiO₂ Layer
Film formation rate: 0.2 nm/sec
Ion assist conditions
   Accelerating voltage: 1000 V
   Accelerating current: 150 mA
O₂ flow rate: 20 sccm
   (Without introduction of Ar)
Film formation temperature: 60° C.

### 2.1.3. Reduction in Resistance

In the antireflection layer 3 of Type A having a seven-layer structure, after forming the sixth layer (TiO₂ layer) 32 and before forming the seventh layer (SiO₂ layer) 31, Si (metal silicon) was added to the surface of the sixth layer by ion-assisted vapor with an argon ion using a vapor apparatus. By this treatment, the surface layer region 33 of the sixth layer 32 was modified such that the sheet resistance (surface resistivity) thereof was reduced. The conditions for reduction in the resistance are as follows. Incidentally, after the resistance of the surface layer region 33 of the sixth layer 32 was reduced, the uppermost layer of the low refractive index layer 31 was formed as the seventh layer by superimposing it on the surface layer region 33 of the sixth layer 32.

Conditions for Reduction in Resistance (Example 1 (Sample S1))
Target layer for addition: TiO₂ layer
Added composition: Silicon
Treatment time: 10 sec
Accelerating voltage: 1000 V
Accelerating current: 150 mA
Ar flow rate: 20 sccm
Treatment temperature: 60° C.

### 2.1.4 Formation of Antifouling Layer

After the antireflection layer 3 was formed, an oxygen plasma treatment was performed in the vapor apparatus using a pellet material impregnated with “KY-130” (trade name, manufactured by Shin-Etsu Chemical Co., Ltd.) containing a fluorine-containing organosilicon compound having a high molecular weight as a vapor source, which was heated at about 500° C. to evaporate KY-130, whereby an antifouling layer 4 was formed. The vapor time was set to about 3 minutes. By performing the oxygen plasma treatment, silanol groups can be generated on the surface of the final SiO₂ layer, and therefore, chemical adhesion (chemical bonding) between the antireflection layer 3 and the antifouling layer 4 can be improved. By doing this, Sample S1 having the hard coat layer 2 formed on one surface of the film base material 1, the antireflection layer 3 which had a layer structure of Type A and in which the resistance of the surface layer region of one of the constituent layers was reduced, and the antifouling layer 4 was obtained.

### 2.2 Other Examples (Type A)

As for the following Examples, samples were produced in the same manner as in Example 1, respectively. However, in the conditions for reduction in the resistance, the following conditions were changed, respectively. In the following, a description is given centering on different conditions from the conditions for reduction in the resistance in Example 1, and the conditions which are not described are the same as those in Example 1.

Example 2 (Sample S2)
Ion assist conditions
   Accelerating voltage: 500 V
   Ar flow rate: 20 sccm

Example 3 (Sample S3)
Ion assist conditions
   Accelerating voltage: 250 V
   O₂ flow rate: 20 sccm
   Ar flow rate: 20 sccm

Example 4 (Sample S4)
Added composition: transition metal silicide (TiSi₂ compound)
Treatment time: 10 sec (corresponding to a film formation rate of 0.08 nm/sec)
Electron beam conditions for heating material
   Accelerating voltage: 7000 V
   Accelerating current: 200 mA
Without ion assist
   Ar flow rate and O₂ flow rate: 0

Example 5 (Sample S5)
Added composition: germanium
Treatment time: 10 sec
Ion assist conditions
   Accelerating voltage: 800 V
   Accelerating current: 150 mA
   Ar flow rate: 20 sccm

Example 6 (Sample S6)
Added composition: germanium
Treatment time: 10 sec
Ion assist conditions
   Accelerating voltage: 500 V
   Accelerating current: 150 mA
   Ar flow rate: 20 sccm

Example 7 (Sample S7)
Added composition: germanium
Treatment time: 40 sec (corresponding to a film formation rate of 0.1 nm/sec)
Electron beam conditions for heating material
   Accelerating voltage: 7000 V
   Accelerating current: 300 mA
Without ion assist
   Ar flow rate and O₂ flow rate: 0

### 2.3 Other Examples (Type B)

As for the following Examples, a film base material 1 was selected in the same manner as in Example 1, and a hard coat layer 2 was formed (see 2.1.1). Further, by using the same vapor apparatus as in Example 1, as shown in the layer structure of Type B of FIG. 2, an antireflection layer 3 was formed using a silicon dioxide (SiO₂) layer as a low refractive index layer 31 and a zirconium oxide (ZrO₂) layer as a high refractive index layer 32. The film forming conditions for the ZrO₂ layer are as follows.

Film Forming Conditions for ZrO₂ Layer
Film formation rate: 0.4 nm/sec
Electron beam conditions for heating material (without introduction of gas)
   Accelerating voltage: 7000 V
   Accelerating current: 300 mA
Film formation temperature: 60° C.

Further, in the antireflection layer 3 of Type B having a five-layer structure, after forming the fourth layer (ZrO₂ layer) 32 and before forming the fifth layer (SiO₂ layer) 31, Si (metal silicon) was added to the surface of the fourth layer by ion-assisted vapor with an argon ion using a vapor apparatus. By this treatment, the surface layer region 33 of the fourth layer 32 was modified such that the sheet resistance (surface resistivity) thereof was reduced. The conditions for reduction in the resistance are twofold as follows. Incidentally, after the resistance of the surface layer region 33 of the fourth layer 32 was reduced, the uppermost layer of the low refractive index layer 31 was formed as the fifth layer by superimposing it on the surface layer region 33 of the fourth layer 32.

Conditions for Reduction in Resistance (Example 8 (Sample S8))
Target layer for addition: ZrO₂ layer
Added composition: Silicon
Treatment time: 10 sec
Accelerating voltage: 1000 V
Accelerating current: 150 mA
Ar flow rate: 20 sccm
Treatment temperature: 60° C.

Conditions for Reduction in Resistance (Example 9 (Sample S9))
Target layer for addition: ZrO₂ layer (However, a surface pretreatment was performed by vapor of TiOx (in this example, x=1.7) for 10 seconds (film formation rate: 0.2 nm/sec) without ion assist on the surface of the target layer for addition.)
Added composition: Silicon
Treatment time: 10 sec
Accelerating voltage: 500 V
Accelerating current: 150 mA
Ar flow rate: 20 sccm
Treatment temperature: 60° C.

After the antireflection layer 3 in which the resistance of the surface layer region 33 of the fourth layer was reduced was formed under the above-mentioned conditions, an antifouling layer 4 was formed in the same manner as in Example 1 (see 2.1.4).

Incidentally, in the above, a description is given by taking the surface pretreatment using TiOx as an example, however, TiO₂ may be used in place of TiOx.

### 2.4 Comparative Example

In order to perform comparison with the samples obtained in the above-mentioned Examples, Samples R1 and R2 having an antireflection layer 3 of Type A and an antireflection layer 3 of Type B, respectively, were produced, by selecting a film base material 1 and forming a hard coat layer 2 in the same manner as in Example 1. Further, an antifouling layer 4 was formed by superimposing it on the antireflection layer 3 of each sample.

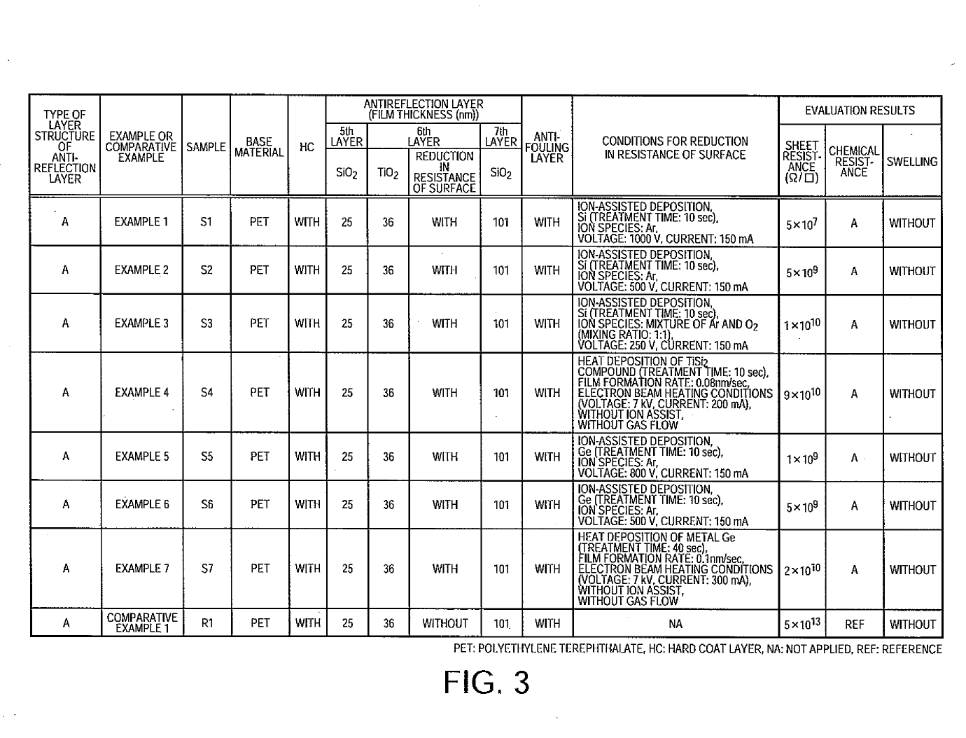

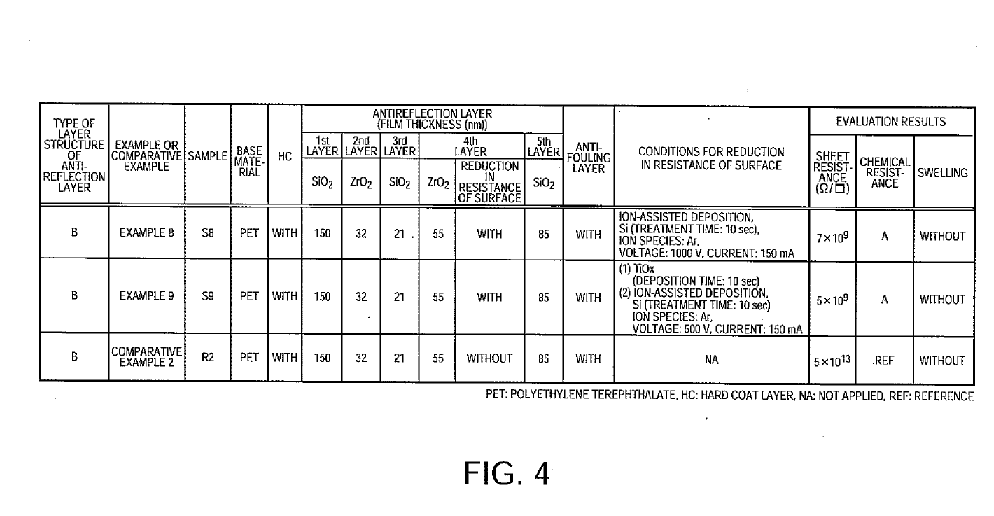

The layer structures of these Samples S1 to S9 and R1 and R2 are summarized in FIG. 3 and FIG. 4.

### 3. Evaluation of Samples

Samples S1 to S9 and R1 and R2 produced in the above were evaluated for sheet resistance, chemical resistance (with or without occurrence of film peeling), and moisture resistance (with or without occurrence of swelling). The results are summarized in FIG. 3 and FIG. 4. Incidentally, in the following measurement, an adhesive layer 5 was formed on the antireflection film 10 of each of Samples S1 to S9 and R1 and R2, and the antireflection film 10 was attached to a transparent glass base plate 100 via the adhesive layer 5 to prepare abase plate for evaluation 101, and the resulting base plate for evaluation 101 was used.

### 3.1 Sheet Resistance

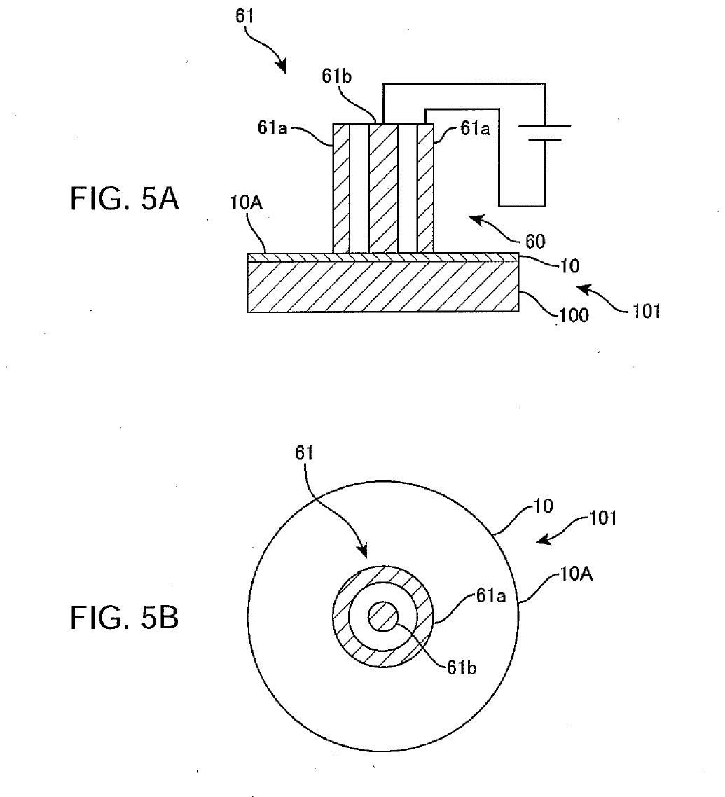

FIGS. 5A and 5B show a way of measuring a sheet resistance of the surface of each sample. In this example, a ring probe 61 was brought into contact with the surface 10A of the film sample 10 attached to the surface of the base plate for evaluation 101 to be measured, and the sheet resistance thereof was measured. As a measuring device 60, a high resistance meter (Hiresta UP MCP-HT450 manufactured by Mitsubishi Chemical Analytech Co., Ltd.) was used. The ring probe 61 used here is URS probe, and has two electrodes: an outer ring electrode 61a and an inner circular electrode 61b. The outer ring electrode 61a has an outer diameter of 18 mm and an inner diameter of 10 mm, and the inner circular electrode 61b has a diameter of 7 mm. A voltage of from 1000 V to 10 V was applied between these electrodes, and the sheet resistance of each sample was measured.

FIG. 3 and FIG. 4 show the measurement results. As shown by the measurement results of Samples R1 and R2, the measurement values of the sheet resistances in the case where the resistance was not reduced are each 5×10¹³ Ω/□. On the other hand, the measurement values of the sheet resistances of Samples S1 to S9 each having a reduced resistance are from 5×10⁷ to 9×10¹⁰ Ω/□. As compared with the conventional samples, the resistance values are reduced by about double to sextuple digits (10² to 10⁶). That is, the sheet resistance is reduced to 1/10² to 1/10⁶. Accordingly, it is found that the sheet resistance is significantly reduced only by modifying the surface layer region 33 of one of the constituent layers of the antireflection layer 3 by the addition of silicon or germanium.

By reducing the sheet resistance of an optical article, several effects are obtained. Typical effects are an antistatic effect and an electromagnetic shielding effect. For example, it is considered that a guide as to whether an optical article has an antistatic property is that the optical article has a sheet resistance of 1×10¹² Ω/□ or less, and it is found that Samples S1 to S9 each have an extremely excellent antistatic property.

### 3.2 Chemical Resistance and Film Peeling

Scratches were made on the surface of each sample, and thereafter, the sample was dipped in a chemical solution. Then, the chemical resistance was evaluated by observing whether or not peeling of the antireflection layer occurred.

### (1) Scratching Step

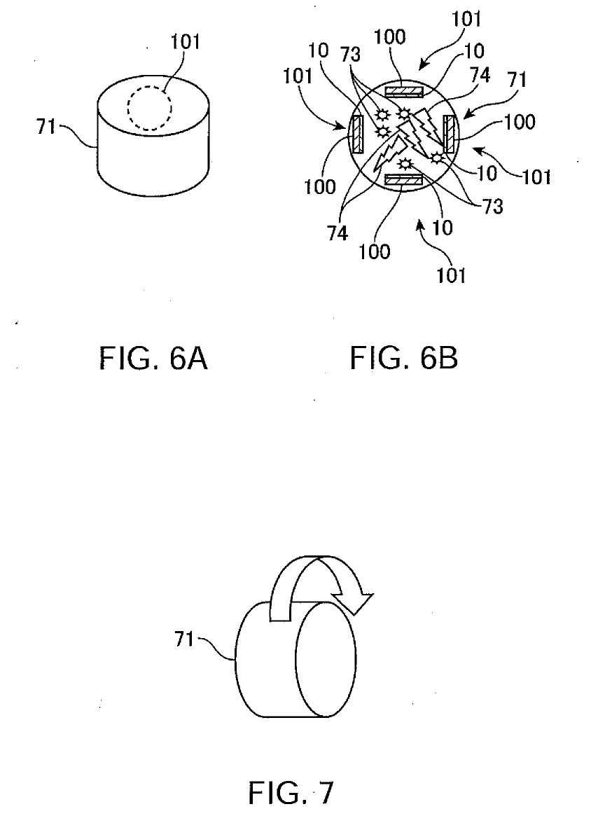

To an inner wall of a container (drum) 71 shown in FIG. 6A, four pieces of the base plates for evaluation 101 were attached as shown in FIG. 6B, and several pieces of non-woven fabric 73 and sawdust 74 for making scratches were placed therein. After putting a cover thereon, the drum 71 was rotated at 30 rpm for 30 minutes as shown in FIG. 7.

### (2) Chemical Solution Dipping Step

A chemical solution (a solution obtained by dissolving lactic acid at 50 g/L and sodium chloride at 100 g/L in pure water) was prepared as artificial human sweat. The base plates for evaluation 101 undergoing the scratching step (1) were dipped in the chemical solution maintained at 50° C. for 100 hours.

### (3) Evaluation

The base plates for evaluation 101 undergoing the above-mentioned steps were visually evaluated by comparison with Samples R1 and R2 which were used as references. The evaluation criteria are as follows.

A: In comparison with the reference samples, almost no scratches are found and the plate has comparable transparency.

B: In comparison with the reference samples, scratches are found, and the plate has poor transparency.

C: In comparison with the reference samples, layer peeling and a lot of scratches are found, and the transparency of the plate is significantly decreased.

As shown in FIG. 3 and FIG. 4, Samples S1 to S9 were all evaluated as A, and an increase in the occurrence of film peeling and a decrease in chemical resistance due to reduction in the resistance were not observed. Accordingly, it is considered that an optical article containing an antireflection layer having a reduced resistance according to the invention is less likely to cause film peeling which occurs in a structure using a metal thin film layer of gold or the like, and also is less likely to cause corrosion which occurs in a structure using a metal thin film layer of silver or the like.

### 3.3 Evaluation for Occurrence of Swelling (Moisture Resistance)

### (1) High Temperature and High Humidity Environment Test

Each of the produced samples was left in a high temperature and high humidity environment (60° C., 98% RH) for 8 days.

### (2) Method for Determining Swelling

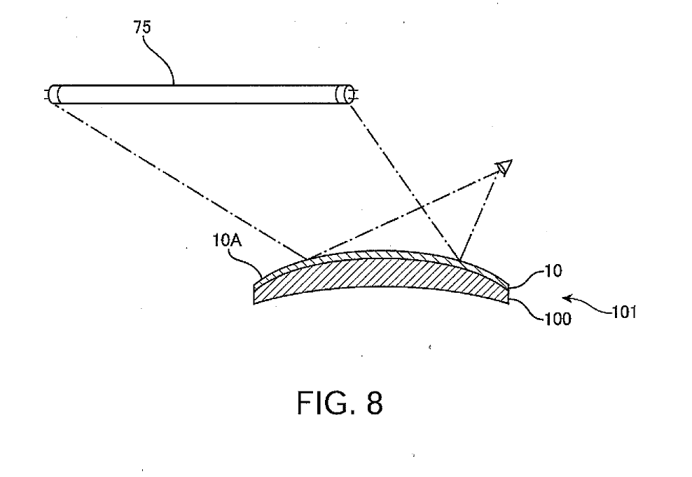

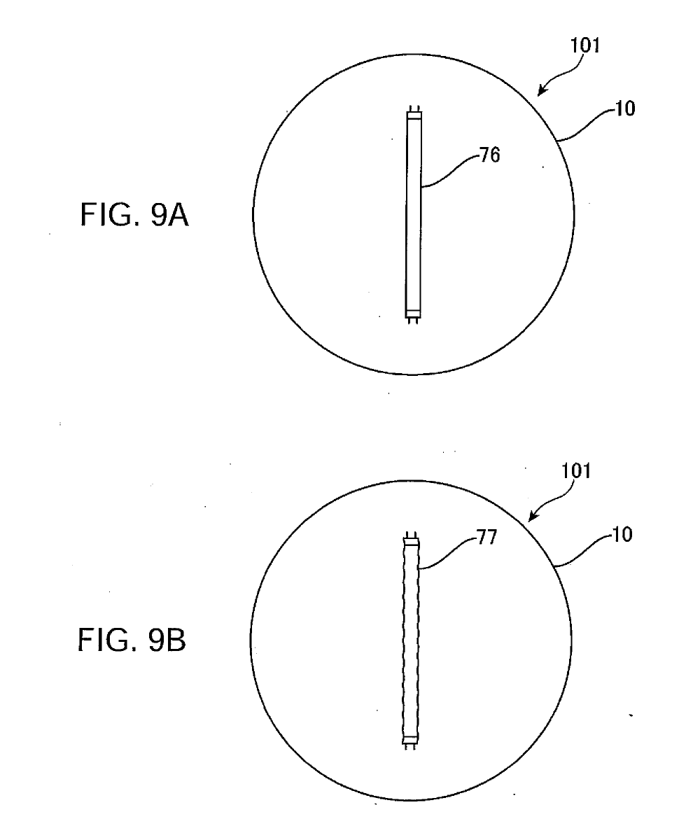

The reflected light from the front or back surface of each sample undergoing the above-mentioned high temperature and high humidity environment test was observed, and occurrence of swelling was determined. Specifically, as shown in FIG. 8, in this measurement, a base plate for evaluation 101 in which a sample 10 was attached to the surface of a convex glass base plate 100 was prepared. The reflected light of a fluorescent lamp 75 from the convex surface 10A of this base plate for evaluation 101 was observed. As shown in FIG. 9A, the case where the outline of an image of the reflected light 76 of the fluorescent lamp 75 could be clearly observed was determined to be “without swelling”. On the other hand, as shown in FIG. 9B, the case where the outline of an image of the reflected light 77 of the fluorescent lamp 75 was blurred or was not clear was determined to be “with swelling”.

### (3) Evaluation

As shown in FIG. 3 and FIG. 4, in Samples S1 to S9 each having a reduced resistance, the occurrence of swelling was not observed and an excellent moisture resistance was exhibited. For example, it is considered that a resistance value is reduced by using ITO (a mixture of indium oxide and tin oxide) which is a transparent conductive film. However, in the above-mentioned experiment, in the case of ITO, swelling occurred, and ITO has a problem that it has poor resistance to a solution of an acid or an alkali. It is considered that an optical article containing an antireflection layer having a reduced resistance according to the invention is less likely to cause swelling which occurs in a structure using ITO.

### 3.4 Discussion

It was found that Samples S1 to S9 obtained in Examples 1 to 9 have a low sheet resistance, and by adding silicon or germanium to the surface, an antireflection film having excellent electromagnetic shielding effect and antistatic effect can be obtained.

An explanation is given by taking the case of silicon as an example below. There is a possibility that by depositing Si (metal silicon) on the surface of a TiO₂ layer 32 which is a high refractive index layer by ion-assisted vapor with an appropriate energy, an amorphous silicon region or part is formed in the surface of the TiO₂ layer 32 or an area which is in the vicinity of the surface of the TiO₂ layer 32 and contains the surface, for example, a region (surface layer region) 33 having a thickness of from sub-nanometer to 1 nm or more. Amorphous silicon is metallic and therefore has a low sheet resistance, and thus, antistatic performance can be obtained.

Further, there is a possibility that by injecting (adding) a Si atom into apart having a thickness of from sub-nanometer to about 1 nm from the surface of the TiO₂ layer 32, TiO₂ constituting the layer 32 and silicon are mixed with each other to cause a chemical reaction. That is, a Si atom is added to (injected or driven into) the TiO₂ layer 32 and chemically reacted with the TiO₂ which is an underlying layer material, thereby modifying the region 33 in the vicinity of the surface. As a result, there is a possibility that in at least a part of the surface layer region 33, titanium silicide such as TiSi or TiSi₂ which is a compound obtained by reacting a Ti atom in the TiO₂ layer with a Si atom is formed. The resistivity of titanium silicide (such as TiSi₂) is as low as from 15 to 20 μΩ·cm (sheet resistance (20 nm) is from 12 to 18 Ω/□), and the electric conductivity can be improved, and therefore excellent electromagnetic shielding performance and antistatic performance can be obtained.

Further, amorphous silicon and silicide are not easily soluble except HF and have high chemical stability. Further, since amorphous silicon and silicide have a similar composition to that of the SiO₂ layer 31 laminated on the TiO₂ layer 32, the mechanical stability of the antireflection layer 3 which is a multilayer film is hardly deteriorated. Moreover, there is a possibility that by modifying the surface layer region 33 of the TiO₂ layer 32 into silicide, the adhesion thereof to the SiO₂ layer 31 can be improved. Accordingly, by adding silicon to reduce the resistance, there are few fears that film peeling or corrosion is easily caused.

As described above, it is considered that by adding silicon to the surface of the TiO₂ layer 32, a region of amorphous silicon or titanium silicide, or an oxide of titanium silicide can be formed in the surface layer region 33 of the TiO₂ layer 32 in whole or in part, and because of the presence of these small conductive regions (regions having a low resistance), the resistance value of the antireflection layer 3 can be reduced, and therefore, the electric conductivity can be improved. Accordingly, the layer to which silicon is added is not limited to a specific layer of the multiple layers constituting the antireflection layer 3, and may be any layer thereof. Further, it is considered that even ,if silicon is injected into the surfaces of plural layers, the same results can be obtained.

Further, the method of injecting silicon is not limited to ion-assisted vapor, and it is considered that by introducing or mixing silicon by another method such as common vacuum vapor, ion plating, or sputtering, the resistance of the antireflection layer 3 can be reduced, and the antistatic performance can be improved.

Further, according to this method, only by modifying a part having a thickness of from sub-nanometer to about 1 nm or a thickness of several nanometers from the surface of the TiO₂ layer 32 through silicon injection, the resistance can be reduced to such an extent that sufficient antistatic performance can be exhibited. Therefore, even if the light absorptance of the composition formed or modified by silicon injection is high, light absorption and the like by the surface layer region 33 can be suppressed to such an extent that it hardly affects the optical performance of the antireflection film 10. Further, since the surface layer region 33 to be modified by silicon injection is very thin and the effect thereof on the optical performance, is small, there may be no need to change the film design of the antireflection layer 3.

From the evaluation results of Samples S5 to S7, it is found that the resistance can be reduced by injection of germanium in place of silicon. The phenomenon occurring in the case of adding germanium can be considered to be similar to that occurring in the case of adding silicon. For example, JP-A-6-302542 describes that the resistivity (sheet resistance) of titanium germanide (TiGe) is 20 μΩ·m. The resistivity of nickel germanide (NiGe) is 14 μΩ·cm which is an equivalent level to that of the above-mentioned titanium silicide (for example, TiSi₂).

Carbon may be added in place of silicon or germanium. For example, the resistivity of SiC is from 107 to 200 μΩ·cm, and the resistivities of TiC and ZrC are 68 μΩ·cm and 63 μΩ·cm, respectively.

Germanium and carbon are Group IV elements like silicon, have the same electronic structure as silicon, and are located in the periodic table immediately below and above silicon, respectively. Each of germanium and carbon has a low sheet resistance in the same manner as silicon when it is a simple substance, and forms a compound having a low resistance with a transition metal in the same manner as silicon. That is, by injecting silicon, germanium, or carbon, the resistance of the surface layer region 33 can be reduced, and an antireflection film which is chemically and mechanically stable, has excellent antistatic performance and electromagnetic shielding performance, can prevent the adhesion of dust thereto, and hardly decreases in the optical property.

As shown in Sample S4, silicon, germanium, or carbon may be injected along with a transition metal capable of forming a compound such as silicide with any of these metals. Further, as shown in Samples S8 and S9, a target layer into which silicon, germanium, or carbon is injected is not limited to a TiO₂ layer, and may be a ZrO₂ layer, and moreover may be another metal oxide layer. Accordingly, the layer structure to which the invention is applied is not limited to TiO₂/SiO₂ or ZrO₂/SiO₂, and the present invention can be applied to a layer structure suitable for constituting the antireflection layer 3 such as Ta₂O₅/SiO₂, NdO₂/SiO₂, HfO₂/SiO₂, or Al₂O₃/SiO₂ to reduce the resistance thereof. Incidentally, the layer structures of the antireflection layer shown in the above-mentioned Examples are illustrative only, and the invention is by no means limited to these layer structures. For example, the invention can be also applied to an antireflection layer having 3 layers or less, or 9 layers or more.

The invention can be applied not only to an inorganic antireflection layer, but also to an organic antireflection layer. For example, an organic antireflection layer is formed on the base material 1. As shown in Sample S9, a surface pretreatment in which a TiOx layer (or a TiO₂ layer) having a thickness of about several nanometers is formed on the antireflection layer without ion assist is performed, and at least any one of carbon, silicon, and germanium is added thereto by ion-assisted vapor, whereby the surface of the organic antireflection layer can be modified.

Further, carbon and silicon are materials which are low in price and are used in many products familiar to the general public. Further, also germanium is often used as an industrial material such as a semiconductor substrate as well as silicon. Therefore, by reducing the resistance using carbon, silicon, or germanium, an antireflection film which is low in price and has excellent antistatic performance and electromagnetic shielding performance can be provided.

As described above, the antireflection film 10 can be used in a system such as a CRT display, a liquid crystal display device, or a plasma display panel. Further, the use of the film is not limited to an optical display device, and the film can be used also in optical products such as window panes, spectacles, and goggles. By using the antireflection film 10, reflection of external light can be prevented and visibility can be improved, and moreover, an antistatic function and an electromagnetic shielding function can be improved. This antireflection film 10 can be provided as an optical article of a flexible film or an optical article attached to a highly rigid glass base plate or plastic base plate.

The entire disclosure of Japanese Patent Application Nos: 2009-050322, filed Mar. 4, 2009 and 2009-199464, filed Aug. 31, 2009 are expressly incorporated by reference herein.

What is claimed is:

1. A process for producing an optical article having an antireflection layer formed directly or via another layer on a flexible optical base material, comprising:
forming a primary layer contained in the antireflection layer; and
adding at least anyone of carbon, silicon, and germanium to a surface of the primary layer to reduce a resistance.

2. The process for producing an optical article according to claim 1, wherein the primary layer is a layer containing a transition metal capable of forming a compound with at least any one of carbon, silicon, and germanium.

3. The process for producing an optical article according to claim 1, wherein the reduction in the resistance includes adding a transition metal capable of forming a compound with at least anyone of carbon, silicon, and germanium to a surface of the primary layer.

4. The process for producing an optical article according to claim 1, wherein
the antireflection layer is a multilayer film; and
the process further comprises forming another layer of the multilayer film by superimposing it on the primary layer.

5. The process for producing an optical article according to claim 1, further comprising forming an adhesive layer on a surface of the optical base material opposite to the surface on which the antireflection layer is formed.

6. An optical article comprising:
a flexible optical base material; and
an antireflection layer formed directly or via another layer on the optical base material, wherein
the antireflection layer has a primary layer containing a surface layer region having a resistance reduced by adding at least any one of carbon, silicon, and germanium thereto.

7. The optical article according to claim 6, wherein the primary layer is a layer containing a transition metal capable of forming a compound with at least any one of carbon, silicon, and germanium.

8. The optical article according to claim 6, wherein the surface layer region contains a compound of at least any one of carbon, silicon, and germanium with a transition metal.

9. The optical article according to claim 6, wherein the antireflection layer is a multilayer film, and the primary layer is one of the layers constituting the multilayer film.

10. The optical article according to claim 9, wherein the primary layer is a layer containing a transition metal capable of forming a compound with at least any one of carbon, silicon, and germanium.

11. The optical article according to claim 6, further comprising an adhesive layer formed on a surface of the optical base material opposite to the surface on which the antireflection layer is formed.

12. The optical article according to claim 11, further comprising abase plate to which the optical base material is attached via the adhesive layer.

13. A system comprising:
the optical article according to claim 6; and
an optical device that inputs and/or outputs light through the optical article.
